(19) United States
(12) Patent Application Publication
(10) Pub. No.: US 2004/0214600 A1
(43) Pub. Date: Oct. 28, 2004

(54) Guest services device

(76) Inventors: Malvin Schechet, Hewlett, NY (US); Lorraine Schechet, Hewlett, NY (US); Alyse Ticker, Brookville, NY (US)

Correspondence Address: Philip M. Weiss, Weiss & Weiss, 310 Old Country Road, Garden City, NY, 11530, US

(21) Appl. No.: 10/614,661

(22) Filed: Jul. 7, 2003

Related U.S. Application Data
(60) Provisional application No. 60/465,193, filed on Apr. 24, 2003.

(51) Int. Cl. H04B 7/00; H04Q 7/20; H04M 1/00; H04B 1/38

(52) U.S. Cl. 455/557; 455/556.2; 455/517; 455/556.1

(57) ABSTRACT

A device which provides a user with access to information and assistance from persons at a guest facility.

### FIELD OF THE INVENTION

The present invention relates to a device which provides a user with access to information and assistance from persons at a guest facility.

### BACKGROUND OF THE INVENTION

When a hotel guest is not in his room, any phone calls he receives will go to his voicemail. The guest, wherever he is at the hotel, must find a house phone to check his messages.

A golfer is held up by the group ahead of him and needs to advise the club's dining room that he will be late for his lunch reservation. Currently, he would need to use his own cell phone minutes to do this, disturbing other golfers in his group.

A resort guest is on the beach with her children. She wants to ask the concierge to make dinner reservations for her and her family. She cannot leave the children on the beach for the children's safety, so she must either take them all with her to find a house phone, or she must wait until the end of the day when their beach outing is over. At a large resort, the distance from the beach to a house phone can be great.

A father is skiing with his son on an isolated back bowl. One of them is badly injured and their cell phone has no reception there. They need to find help fast.

U.S. Pat. No. 6,055,512 relates to a networked personal customized information and facility services. A service terminal facility is provided at a public access location, for example in a hotel, hospital or airport, the service terminal facility available for providing electronic information services to users, in response to input of a portable data storage medium, for example a smart card or the like. A smart card contains stored data describing user specified information such as contact names, personal details and medical information and personal interest information. The service terminal comprises a search engine for searching the user data and comparing data types within the user data with general data stored locally at the service terminal. The service terminal selects data corresponding to data types specified in the user data and displays these on the graphical user interface at the service terminal, or at a user interface connected with the service terminal. The user may specify one or more data sources or service providers from which electronic data services of interest to the user can be obtained. The service terminal may obtain listings of data from remote data sources and/or service providers and display there on the graphical user interface and/or user interface. The user may instruct downloading of electronic data or electronic information services from remote data sources or service providers from the service terminal for delivery to the graphical user interface or the user interface.

U.S. Pat. No. 4,752,876 relates to a self service terminal for lodging industry including room key dispenser. The invention allows a guest to automatically check into a lodging facility, have an appropriate room assigned to him in accordance with his request and obtain a key for a room without the intervention of employees of the lodging facility. The invention also includes an apparatus and method for allowing a guest of a lodging facility to check out at the self service terminal upon departure without intervention by employees of the lodging facility, with the self service terminal recovering the room key which the guest had been using.

U.S. Pat. No. 6,005,561 relates to an interactive information delivery system, which includes a head end broadcasting a data stream of media objects, the head end being coupled to a broadcast television interface and at least one information service provider and including an encoder for encoding information in the media object. The system may deliver and implement a programming guide delineating programming information available on the information delivery system in one or more media objects in the data stream in an encoded fashion by the encoder. A user terminal is coupled to the head-end and receives the media objects. The user terminal has an output and includes a decoder for the media objects. In one aspect is a user interface, at least partially stored in the user-terminal, which selects a user-defined subset of media objects for provision to the output of the user terminal. An information navigation system for an information delivery system is provided. The navigation system functions with the electronic program guide and includes a user interface having a plurality of icon representations of various functions of the system, and including a broadcast television interface. The navigation system also includes a smart service navigator which interacts with the user interface and the electronic program guide to provide an output.

The invention relates to delivery, selection and communication of information in an interactive format, and specifically to the delivery and selection of information delivered to a television user over a cable television system.

U.S. patent application Ser. No. 2002/0090072 relates to a method and system for providing a remote call accounting system. The invention provides a method and system for remotely processing a data string. The method includes the steps of generating a data string from a communications device, which may be a telephone or modem, and attaching an identifier code to the data string. The data string is then transmitted to a remote processor that reads the identifier code and processes the data string according to an algorithm designated by the identifier code. The invention provides for remotely generating a hotel guest bill.

U.S. patent application Ser. No. 2003/0073434 relates to a voice-controlled wireless communications system and method. The wireless communication system has a central computer, one or more wireless access points and one or more personal badges that communicate wirelessly with the one or more wireless access points. The badges provide the user with a communications device that permits the user to initiate telephone calls and conferences, receive telephone calls, receive pages and be located within a particular environment.

U.S. Pat. No. 4,956,861 relates to a method and apparatus used with a private branch exchange for addressee location. An addressee notifies of his or her present location by a predetermined dialing operation from an extension telephone, other than an extension telephone allotted to him or her within the private branch exchange system , whereupon a switchboard of the system stores the location of the addressee in association with the extension telephone from which the notification was made. Upon arrival of an incoming call for the extension telephone allotted to the addressee, the switchboard transfers the call to a switchboard operation device which displays the addressee's location. The apparatus further comprises a character display section, the switchboard operation device adapted to operate the switchboard of the PBX system, a memory unit for storing the location name for each extension telephone connected to the switchboard and a profile of each specific addressee, an input unit for entering into the memory unit the location name of each extension telephone and the profile of each addressee, and a switchboard control unit which, upon a predetermined dialing operation by an addressee from an extension telephone other than the one allocated to him or her, stores the addressee's location at that time point in the memory unit, and if a call arrives for the extension telephone allotted to the addressee under this condition, transfers the call to the switchboard operation unit while at the same time indicating the addressee's present location on the switchboard operation unit.

The invention is specifically applicable to a guest location system suitable for reaching by telephone a hotel guest who is using some hotel facilities outside of their room in the hotel. The invention operates that when a guest is some place outside their room, and is desirous of being contacted by telephone at that particular place, the guest has the identification place stored in the exchange by an exclusive terminal unit so that a call addressed to their room, if any, may be transferred to the designated place of destination.

U.S. patent application Ser. No. 2003/0083889 relates to a hotel guest services online. The system includes one or more guest client devices located in the guest room and connected to a server. One or more service client devices also connected with the server are located throughout the hotel in the various service areas of the hotel and elsewhere. The various on-line services provided by the system, such as the ability to order room service, schedule wake-up calls, request house keeping, access on-line gambling, and others, are displayed on the guest client device. When a guest requests one of the on-line guest services, the request is displayed on the appropriate service client device associated with the request.

The invention specifically relates to services which are accessed through links on the guest client device in the guest's room, and displayed on various service client devices strategically located throughout the hotel in the appropriate service area of the hotel.

U.S. patent application Ser. No. 2002/0111213 relates to a method, apparatus and article for wagering and accessing casino services. An integrated system for identifying casino customers, placing wagers and tracking wins and losses, and for placing reservations and services, that is capable of automatically verifying that sufficient funds are available, and that tracks the cumulative amounts of money won, lost and spent by a customer. A hand-held wireless communications device includes a biometric sensor to measure at least one piece of biometric data from a customer during operation which is compared to a previously measured piece of reference biometric data to authenticate the request. One or more receivers receiving request from a handheld wireless communications device accepts the requests if the requests originated from within an area having access restricted to customers meeting the desired criteria, such as minimum age. Automatic notification of a wagering results are provided. Updated cumulative totals of funds remaining in a customer's account are tracked and displayed. The system can automatically verify that sufficient funds are available to pay for such requested wagers, reservations and services.

The wireless communications device allows the customer to automatically transmit requests for wagering and guest services, such as reservations for accommodations, meals, drinks, and shows. A host computing device can receive these requests, and automatically enter the requested wagers, reservations and/or service requests. The host computing device can verify that the customer's account has sufficient funds to pay for such services before entering the requests. The host computing device can automatically debit the customer's account for the requested wagers, reservations, and/or services, and provide a confirmation of the acceptance of the request along with an updated cumulative total of the funds remaining in the customer's account.

A casino automation system includes at least one handheld wireless communications device, and a casino based computing system. The casino based computing system includes a host computing device that communicates with the wireless communications device via one or more receivers and one or more transmitters. The receivers receive wireless signals from the communications device and the transmitters transmit wireless signals to the communications device. The casino based computing system can also include one or more reservations databases for tracking and entering reservations for a variety of services such as accommodations, restaurants, shows and other entertainment. The casino based computing system can also include one or more services databases for tracking and entering requests for a particular guest services, such as requests for room service, room cleaning service, laundry, valet parking, and other services typically associated with a hotel and/or casino.

The wireless communications device includes a housing and a display. The display can display at least a portion of a user interface, such as a graphical user interface, to allow a customer to interact with the wireless communications device. The display can take the form of a touch-sensitive display, allowing the user to enter and/or commands by touching the display with a finger and/or stylus. The wireless communications device cans also include user selectable keys or buttons for operating the communications device. The wireless communications device can also include a speaker and a microphone to allow the customer to interact with the wireless communications device.

The memory of the communications device can also include additional communications or networking software for wired and/or wireless communications on networks, such as local area networks, wide area networks, or the Internet.

An availability module can determine the availability of wagering games, reservations, and/or services and can transfer information regarding the availability to the communications device for display to the customer. An enter request module accepts and places the wager, reservation and/or service request. For example, the enter request module can automatically reserve seats for a show or meal at a casino facility and/or external facility. The enter request module can implement the reservation by placing an entry in an electronic seating database, or by providing a notification to the appropriate personnel. The enter request module can enter a service request by notifying the appropriate server of the request, such as automatically logging a drink order in an electronic queue at a bar. The device includes a number of user-selectable prompts for display on the display of the wireless communications device. The window includes prompts for selecting wagering games, prompts for making reservations, prompts for ordering services, and prompts for manipulating and inquiring about the customer's account. The customer can determine whether reservations are available for accommodations, meals or shows and other entertainment. The customer can place the reservations by selecting one of the reservation prompts to go to an appropriate web page or user input window. The customer can request services, such as room service or laundry service by selecting one of the service prompts.

One embodiment shows a window for making dinner reservations. The window contains a meal reservations grid showing the days of the week as columns extending across the top of the grid and dinner hours as rows extending down the left side of the grid. In this embodiment, the user can only make reservations when the date and time is available. The show reservations grid includes additional rows corresponding to different seating designations.

In an embodiment, the customer enters a request for information regarding available wagers, reservations and/or services into the communications device. The transceiver transmits the request for information externally from the communications device. The host computing device receives the request for information via the receiver. The host computing device transmits the requested information via the transmitter. The communications device receives the requested information transmitted from the host computing device via the transceiver. The communications device displays the requested information to the customer using the display. The device can provide notification of the acceptance of a reservation or service request. This device is restricted in use and only functions when it is used in the casino area.

The problem with the prior art is that none of these devices allow a user to communicate with the services provided by the hotel or other guest service institution, or provide the user with information regarding the facility in real time. Further, none of these devices provide instant access to emergency services. Prior art does not provide any feedback to host management, and the prior art does not provide all the guest services information along with telephone, video, and emergency response.

### SUMMARY OF THE INVENTION

The present invention can resolve each of the above situations. The present invention relates to a handheld wireless device with telephone and Internet access, video, customizable keypad, display panel, stylus, and earpiece. It is an object of the present invention to provide pager capability. It is an object of the present invention for the device to be waterproof and sandproof. It is an object of the present invention for the device to fit inside a person's pockets. It is an object of the present invention to provide the user a password to the device, in case the device is lost or stolen. It is an object of the present invention for the user's key to their room to function as an access code to the guest services device. It is an object of the present invention for the guest services device to store a user's room key. It is an object of the present invention for the device to be rechargeable.

It is an object of the present invention for the device to have stored in it all of the guest service facility numbers which would be of interest to a guest. It is an object of the present invention to be able to transfer all of the calls of a guest from the room phone to the device of the present invention. It is an object of the present invention to be able to forward a guest's emails to the device of the present invention. It is an object of the present invention to be able to track a person's whereabouts who has possession of the guest service device.

It is an object of the present invention for the device to connect the user to the various systems (telephone, computer) of a host guest services facility (host), such as a hotel, golf club, tennis club, ski area, beach resort, college or university, cruise ship, marina, corporation.

The host facility provides the user with the device of the present invention. It is an object of the present invention to provide a user with more than one device per family or guest for use during their stay.

It is an object of the present invention for the device to include wireless telephone. It is an object of the present invention for the device to include wireless Internet access. It is an object of the present invention to give the user one-touch access to the host's email system. It is an object of the present invention for the host computer system to provide feedback to the user. It is an object of the present invention for the host's computer systems to provide feedback to the host. It is an object of the present invention to provide the host management with real-time requests for services.

### BRIEF DESCRIPTION OF THE DRAWINGS

FIG. 1 is an open view of the device;

FIG. 2 is an open view of the device; and

FIG. 3 is a front view of the device.

### DETAILED DESCRIPTION OF THE INVENTION

The present invention relates to a handheld wireless device. In a preferred embodiment, the device has telephone and Internet access, and video capability. In a preferred embodiment, the device has a customizable keypad, display panel, stylus, and earpiece.

With video capabilities, users and hosts can take complete advantage of access to the Internet and the host's computer. For example, a guest at a large resort can use the device to preview the children's activities center to decide whether to take the children from the pool to the activity center. From anywhere on the property, a guest can use the video to show hotel management their Government issued photo identification when required for any transaction.

In an embodiment, the device has pager capability. In an embodiment, the device is waterproof and sandproof. In a preferred embodiment, the device fits inside a person's pocket. The device should be password protected or have some kind of lock and key in case the device is lost or stolen. In an embodiment, a user's key to their room functions as an access code to the guest services device. In an embodiment, the guest services device stores a user's room key. In an embodiment, the device is rechargeable.

In a preferred embodiment, the device of the present invention has stored in it all of the guest service facility numbers which would be of interest to a guest.

In a preferred embodiment, the user can transfer all of the calls of a guest from the room phone to the device of the present invention. In a preferred embodiment, the user can forward their emails to the device of the present invention. In a preferred embodiment, the user can track the whereabouts of the other users in their family who are holding the device. In a further embodiment, the host can track the whereabouts of the persons holding the guest device.

In a preferred embodiment, the device connects the user to the various systems (telephone, computer) of a host guest services facility (host), such as a hotel, golf club, tennis club, ski area, beach resort, college or university, cruise ship, marina, corporation.

The host facility provides the user with the device of the present invention. In an embodiment of the present invention at a transitory host facility, such as hotel, ski area, beach resort, host management provides guests with at least two units of the present invention per family for use during their stay. The guests would be responsible to return the units of the present invention in good working order to the host facility. At a membership host facility, such as a private golf club, tennis club, pool club, sports club, marina, college or university, host management would provide members or students the option to purchase or lease the units of the present invention from host management.

In an embodiment, the device of the present invention includes wireless telephone. This feature will give the user access to the host's telephone system. In the case of the hotel guest not in his room when a call is sent to his room, after the room phone goes unanswered, the switchboard will, if directed by the user, forward the call to device of the present invention. With the device of the present invention, the user has complete control over when and where he receives phone calls, and the user does not need to return to his room or a house phone to check on missed calls. With its wireless telephone, the present invention allows the father and son skiers to call for help immediately. In this case, the host programmed device of the present invention with an “EMERGENCY” speeddial button which the skiers will use to call the host's ski patrol. A corporation or tennis club host might choose to program an “EMERGENCY” speeddial button with the local municipality's emergency response services number.

The guest on the beach who needs the concierge will also use wireless access to the hotel's telephone system. With device of the present invention the guest will remain with her children, whom she cannot leave alone on the beach, and call the concierge with her reservation request. The concierge calls her back on the device of the present invention directly with the dinner reservations, or leaves her a message in her room, whatever the guest's preference. Further, the “EMERGENCY” speeddial on the device provides for the safety of her children.

In an embodiment, the device includes wireless Internet access. This feature gives the user one-touch access to the host's email system. The golfer mentioned above who is delayed on the course and needs to advise the dining room that he will be late does not want to use his private cell phone minutes and does not want to disturb other golfers by making a phone call. With the device of the present invention the user can easily email the dining room, and get back to his game.

The present invention's Wireless Internet access will also give users one-touch access to authorized areas of the host's computer systems. For example, a user on a cruise ship could do all of the following from a deckchair overlooking the ocean: access his current room charges; check the notes on his reservation regarding what time his luggage must be ready on the morning of debarkation; look up the time and location of one of the evening's shows so he can make plans with new friends he just met; order from the room service menu for cocktails and appetizers to be delivered to his stateroom for a small party in his stateroom later with his new friends; request and confirm a massage from the ship's spa services.

In an embodiment, the host's computer systems can provide feedback to the user. If the cruise passenger user requests a massage time that is unavailable, the system will respond with alternate times for his selection. In an embodiment, if the user requests room service that exceeds his shipboard credit limit, the system will not accept the order and will advise him properly.

In an embodiment, the host's computer systems can provide feedback to the host. Host management can see real-time requests for services. This provides host management with valuable information regarding use and allocation of their resources. It also provides host management with valuable information regarding the patterns of their guests. This enables host management immediate reporting to budget their money wisely.

In an embodiment, the device can be used by a corporate office. For example, the device can store all of the numbers from the Office. Also the device can allow a user to receive phone calls transferred from the user's desk when they are out to lunch, or at a meeting. Further the device can allow a user to receive emails when they are not at their desk. The device can also be used to track the whereabouts of a firms' employees. A guest of a corporation can use the device to easily find information from authorized areas of the corporation's computer systems. For example, perhaps the guest is a consultant to the corporation. The corporation can provide the guest consultant with a device that allows access into specific company databases so the consultant can easily work while interviewing corporation employees throughout the building.

In an embodiment, parents would visit their child's college or university campus. The parent would like to know all the events of the day. With the device of the present invention, they can instantly log on to the campus activities schedule, go to websites of specific campus organizations, order tickets for events, call their child, and coordinate their plans.

A student at a university or college would have access to every access of student life from anywhere on campus. The student could use the device to check on cost registration. If there was a billing problem, the student can be notified and could use the device to resolve the billing problem by phone, e-mail, and direct payment to the billing department's computer. The student could then use the device to complete cost registration.

Below is a list of potential applications:

Resorts/Hotels/Cruise Ships

front desk/check-in/out

bell captain/valet parking

concierge/shore excursions

laundry, dry cleaning services

room service

engineering, housekeeping services

spa/health club

salon, barber shop

restaurants, nightclubs, showrooms

childcare, game rooms

property transportation (shuttles, trains, boats)

guest voicemail

security/gatehouses

business center

pool activities desk

conference rooms/banquet facilities

medical facility

library/lounges

speeddial “EMERGENCY” access

all features of golf/tennis clubs listed below

Golf Course/at Hotel and Private Country Club

locker room

pro-shop

starter desk

restaurants

day care/playground

access all property facilities

speeddial “EMERGENCY” access

Tennis Courts/at Hotel and Private Country Club

locker room

pro-shop

daycare/playground

restaurants

access all property facilities

speeddial “EMERGENCY” access

Beach/at Hotel and Private Beach Club

life guards

snack areas/restaurants

locker room

daycare/playground

access all property facilities

speeddial “EMERGENCY” access

Colleges and Universities—Library

administration

academics

social halls

athletic facilities/stadiums

dining rooms/lounges/pubs

student activities

residential buildings

bookstore

off-campus housing

fine arts/museum

performing arts/theatres

campus security/gatehouses

medical facility

daycare

speeddial “EMERGENCY” access

Ski Areas—Lift Ticket Office

ski equipment rental

restaurants/bars

ski patrol

medical facilities/clinic

members' lounge

ski school

area accommodations office

transportation desk

avalanche/emergency office

speeddial “EMERGENCY” access

Corporations—Email

phone/voice mail

library

conference/meeting schedule and registration

human resources database

marketing database

research and design

advertising plan

corporate travel agent

local transportation/accommodations

speeddial “EMERGENCY” access

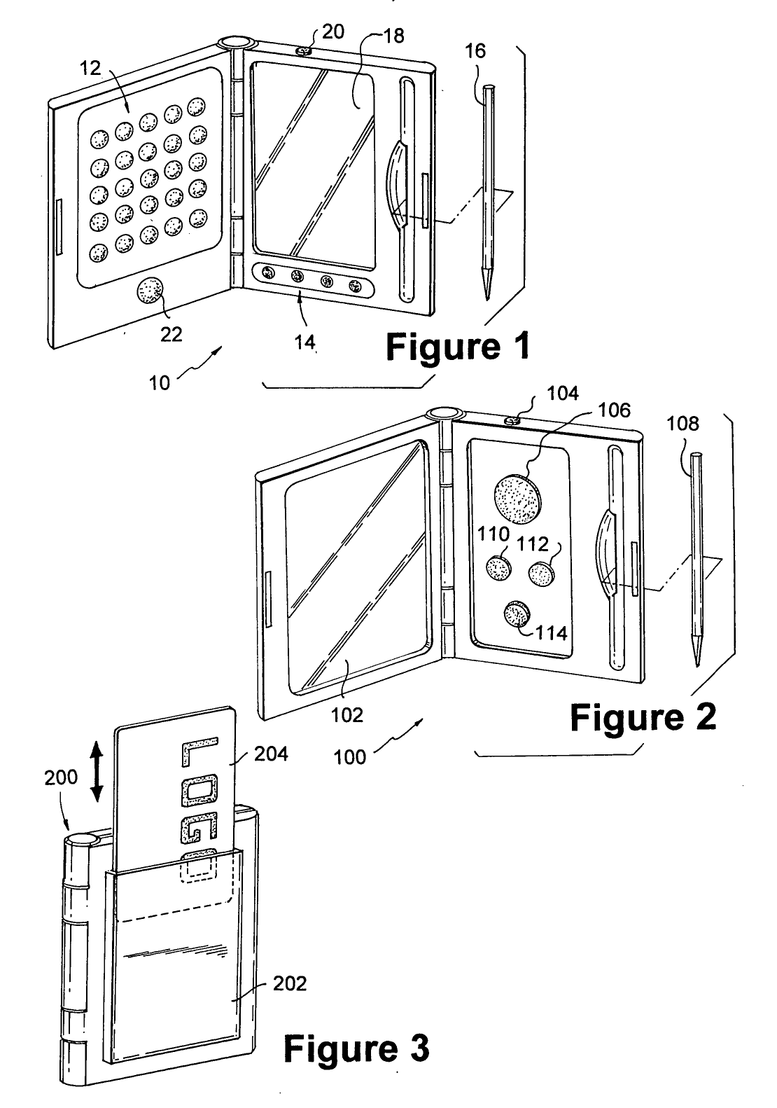

FIG. 1 shows an open view of device 10. Device 10 has a customizable keypad 12 which can be customized by the facility it is used in. A display 18 can be a video display. In an embodiment, the video display can provide information concerning what events are occurring at the facility. Controls 14 are shown on the device 10. A stylus 16 is shown attached to the device. A retractable earpiece 20 is attached to the device 10. A speeddial “EMERGENCY” button 22 is available for the user.

FIG. 2 shows an open view of device 100. A video display 102 is on one side of device 100. A retractable earpiece with a microphone 104 is attached to device 100. A speeddial “EMERGENCY” button 106 is available for the user. The device allows the user to use the device as a phone, control 110, on property e-mail 112, and on property computer system 114. A stylus 108 is attached to the device.

FIG. 3 shows a front view of device 200. A key slot 202 is placed on the front of the device for receiving key 204. Key 204 acts as an access means for opening the device and allowing its use.

1. A handheld wireless device comprising:
telephone, Internet access, and video;
wherein said device is connected to a host computer.

2. The device of claim 1 further comprising:
a customizable keypad, display panel, stylus, and earpiece.

3. The device of claim 1 further comprising:
a pager.

4. The device of claim 1 wherein said device is waterproof and sandproof.

5. The device of claim 1 wherein said device fits inside a person's pockets.

6. The device of claim 1 wherein said device is password protected.

7. The device of claim wherein a user's room key functions as an access code to said device.

8. The device of claim 1 further comprising a storage area for a user's room key.

9. The device of claim 1 wherein said device is rechargeable.

10. The device of claim 1 wherein said device has stored in it all guest service facility numbers which would be of interest to a guest.

11. The device of claim 1 wherein said device transfers all calls of a guest from a room phone to said device.

12. The device of claim 1 wherein said device forwards a guest's emails to said device.

13. The device of claim 1 wherein a person can track a person's whereabouts who has possession of said device.

14. The device of claim 1 wherein said host computer system provides feedback to a user.

15. The device of claim 1 wherein said host computer system provides feedback to a host.

16. The device of claim 15 wherein said device provides real-time requests for services.
